(19) United States
(12) Patent Application Publication
(10) Pub. No.: US 2015/0211480 A1
(43) Pub. Date: Jul. 30, 2015

(54) SYSTEM AND METHOD FOR STORING ENERGY

(71) Applicants: Frank C. Pingitore, Little Silver, NJ (US); Michael J. Pingitore, Aberdeen, NJ (US)

(72) Inventors: Frank C. Pingitore, Little Silver, NJ (US); Michael J. Pingitore, Aberdeen, NJ (US)

(21) Appl. No.: 14/510,175

(22) Filed: Oct. 9, 2014

Related U.S. Application Data
(63) Continuation-in-part of application No. PCT/US2013/035801, filed on Apr. 9, 2013.
(60) Provisional application No. 61/622,097, filed on Apr. 10, 2012.
(60) Provisional application No. 61/770,624, filed on Feb. 28, 2013.

(51) Int. Cl. F03B 17/06; H02K 7/18; F03G 3/00

(52) U.S. Cl. CPC F03B 17/06; F03G 3/00; H02K 7/1853; Y10S 415/916; F03B 17/005

(57) ABSTRACT

Embodiments of the disclosure provide an energy storage system comprising: at least one linkage; a respective attachable and detachable west and east weight attached to the west and east ends, respectively, of the at least one linkage; a west bladder and an east bladder attached to the west weight and the east weight, respectively; a west reservoir and an east reservoir, wherein the west reservoir is connected to the east bladder by a transfer pipe, and the east reservoir is also connected to the west bladder by another transfer pipe, and wherein the west reservoir connects to the west bladder by a discharge pipe and a connection device, and the east reservoir also connects to the east bladder by another discharge pipe and connection device; a gear and chain system; and an energy converter. One or both bladders may be multi-chambered.

### CROSS-REFERENCE TO RELATED APPLICATIONS

This application is a continuation in part of International Patent Application Serial Number PCT/US2013/035801, filed Apr. 9, 2013, the entire content of which is hereby incorporated by reference in its entirety. PCT/US2013/035801 in turn claims the benefit of both U.S. Provisional Patent Application Ser. No. 61/622,097, filed on Apr. 10, 2012, the entire content of which is hereby incorporated by reference in its entirety, and U.S. Provisional Patent Application Ser. No. 61/770,624, filed on Feb. 28, 2013, the entire content of which also is hereby incorporated by reference in its entirety.

### BACKGROUND

1. Field

The following relates to a system and method for storing energy. More specifically, the following relates to a system and method for storing energy through the use of weights and the transfer of fluids in a closed-loop system.

2. Related Art

Electricity is mainly generated by fossil fuels, such as coal, nuclear energy, or hydro energy. Fossil fuels are non-renewable and are being exhausted at a rapid rate. In addition, the burning of fossil fuels to generate electricity produces much pollution, which can be extremely harmful to both living things and the environment. Likewise, nuclear power generation produces nuclear waste that poses extreme health risks to people. Hydro energy is the safest form of energy production. However, its reach is limited as it requires favorable locations where a water source is plentiful for hydro dams to be built. Furthermore, all of these sources of energy are heavily regulated.

To avoid these concerns, various forms of alternative energy have been developed over the years to replace the fuel sources. These include solar energy, wind energy, and geothermal energy, among others. However, these forms of alternative energy have different disadvantages. For instance, they are very expensive to implement and to maintain. Additionally, certain regions may not take advantage of these alternative energy sources as they are not readily available in those regions.

As such, people have tried to develop other, more accessible energy systems that utilize renewable resources. For example, the Power Generation Apparatus in U.S. Publication No. 2011/0126538 to Kim attempts to generate power through the use of fluids and weights. However, the system is an open-loop fluid system, which requires regular input of outside energy and fluid to overcome the presence of atmospheric pressure, head, and frictional forces. This minimizes the net gain of power generated by the apparatus. Furthermore, the apparatus generates power only through half of a cycle of operation, further reducing the net power gained from a certain input of power.

Therefore, a need exists for a system and method for power generation and/or energy storage that produces alternative energy in a clean, efficient and cost-effective manner without depleting the world's source of natural resources or producing harmful effects to living things and/or the environment, and that is readily available to everyone.

### SUMMARY

Embodiments of the present invention generally relate to a system for generating alternative energy wherein the system utilizes weights and the transfer of fluids in a closed-loop system to generate kinetic energy to be converted into electricity. In one embodiment of the present invention, there is provided a closed-loop power generation system comprising: at least one linkage; a west weight and an east weight attached to the west and east ends, respectively, of the at least one linkage; a west bladder and an east bladder attached to the west weight and the east weight, respectively; a west reservoir and an east reservoir, wherein the west reservoir is connected to the east bladder by a transfer pipe, and the east reservoir is also connected to the west bladder by another transfer pipe, and wherein the west reservoir connects to the west bladder by a discharge pipe and a connection device, and the east reservoir also connects to the east bladder by another discharge pipe and connection device; a gear and chain system; and an energy converter. Each of the transfer pipes further comprises a backflow prevention device to control the flow of the fluid in the direction of the bladders to the reservoirs. Each of the discharge pipes further comprises a connection device to connect each bladder to the respective reservoir, and a valve to control the discharge of the fluid from the reservoirs to the respective bladders.

In accordance with another embodiment of the present invention, there is provided a method for storing energy comprising: providing a power generation system described in the embodiment above; filling the reservoirs and transfer pipes with a fluid; positioning the power generation system in its startup position wherein either the west bladder is connected to the west reservoir or the east bladder is connected to the east reservoir; starting the operation of the power generation system by opening the valve of the discharge pipe to allow fluid to flow from the reservoir to the connected bladder in the startup position; closing the valve when the fluid in the connected bladder reaches a desired level; releasing the device connecting the reservoir and the bladder such that the reservoir and bladder are no longer connected; and storing the energy converted from the kinetic energy generated from the motion of the power generation system. These steps may be mirrored when the other bladder connects to the other reservoir after the first bladder empties the fluid.

### BRIEF DESCRIPTION OF THE DRAWINGS

So the manner in which the above recited features of the present invention may be understood in detail, a more particular description of embodiments of the present invention, briefly summarized above, may be had by reference to embodiments, several of which are illustrated in the appended drawings.

Figures in the appended drawings, like the detailed description, are examples. As such, the Figures and the detailed description are not to be considered limiting, and other equally effective examples are possible and likely. Furthermore, like reference numerals in the Figures indicate like elements, and wherein:

FIG. 1 is a plan view of a power generation system near a starting point of a clockwise motion in accordance with an embodiment of the present invention;

FIG. 2A-2B are perspective views of embodiments of a hub assembly in accordance with the present invention;

FIG. 3 is a plan view illustrating a power generation system at a point during clockwise motion in accordance with an embodiment of the present invention;

FIG. 4 is a plan view illustrating a power generation system at another point during clockwise motion in accordance with an embodiment of the present invention;

FIG. 5 is a plan view illustrating a power generation system at another point during clockwise motion in accordance with an embodiment of the present invention;

FIG. 6 is a plan view illustrating a power generation system at a point when fluid has been transferred to one side in accordance with an embodiment of the present invention;

FIG. 7 is a plan view of a power generation system near a starting point of a counter-clockwise motion in accordance with an embodiment of the present invention;

FIG. 8 is a plan view illustrating a power generation system at a point during counter-clockwise motion in accordance with an embodiment of the present invention;

FIG. 9 is a plan view illustrating a power generation system at another point during counter-clockwise motion in accordance with an embodiment of the present invention;

FIG. 10 is a plan view illustrating a power generation system at another point during counter-clockwise motion in accordance with an embodiment of the present invention;

FIG. 11 is a plan view illustrating a power generation system at a point when fluid has been transferred to another side in accordance with an embodiment of the present invention;

FIG. 12A is a perspective view of a west bladder assembly and west weight assembly in accordance with an embodiment of the present invention;

FIG. 12B is a perspective view of an east bladder assembly and east weight assembly at a weight transfer point in accordance with an embodiment of the present invention;

FIG. 12C is a perspective view of a west weight assembly and a west bladder assembly at a point of compression in accordance with an embodiment of the present invention;

FIGS. 13A-B are front plan views of a reset device to reset the power generation system in accordance with one embodiment of the present invention.

FIG. 14 is a perspective view drawing of a contact component of a power generation system in accordance with one embodiment of the present invention;

FIGS. 15A-B are flowcharts illustrating an exemplary method in accordance with one embodiment of the present invention;

FIG. 16 is a cross-sectional view of one embodiment of a multi-chamber bladder;

FIG. 17 is a cross-sectional view of another embodiment of a multi-chamber bladder;

FIG. 18 is a cross-sectional view of one embodiment of a multi-sectional bladder;

FIG. 19A is a cross-sectional view of one embodiment of a multi-chamber bladder with internal valving; and

FIG. 19B is a cross-sectional view of another embodiment of a multi-chamber bladder with internal valving.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to. The drawings are not intended to be drawn to scale unless clearly stated or implied by the surrounding context of reference.

### DETAILED DESCRIPTION

In the following detailed description, numerous specific details are set forth in order to provide a thorough understanding of embodiments or other examples described herein. In some instances, well-known methods, procedures, components and circuits have not been described in detail, so as to not obscure the following description.

Further, the examples disclosed are for exemplary purposes only and other examples may be employed in lieu of, or in combination with, the examples disclosed. It should also be noted the examples presented herein should not be construed as limiting of the scope of embodiments of the present disclosure, as other equally effective examples are possible and likely.

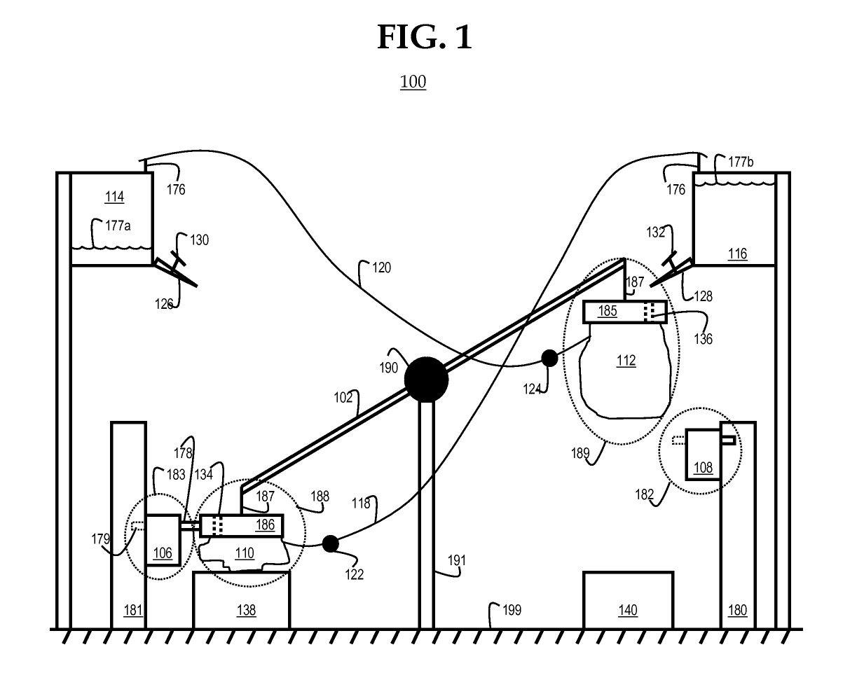

FIG. 1 illustrates a plan view of power generation system 100 in accordance with an embodiment of the present invention. Power generation system 100 can generally be described as having a west half (i.e., left half) and an east half (i.e., right half), such that each half includes substantially the same components. Components of power generation system 100 rest directly or indirectly upon a support surface 199. Power generation system 100 includes at least one arm linkage 102 that spans substantially the length of the system east to west. Linkage 102 is generally made of a rigid material, such as aluminum, steel, and the like, such that it will be able to support a weight at each end without breaking or significant bending. Additional arm linkages may be provided, which may help to ensure stable operation during motion. Arm linkages help maintain a steady vertical movement without swaying when the power generation system 100 is in operation.

Linkage 102 is designed to pivot alternately clockwise and counterclockwise around a hub 190. Hub 190 may include appropriate gearing, ratcheting, drive belts, or the like in order to harvest the pivot action of linkage 102 into rotary mechanical power, and from there to electrical power. Hub 190 may be supportively coupled to hub support 191. Hub 190 will be further described below.

Power generation system 100 further includes an east bladder assembly 189 and west bladder assembly 188 on east and west ends of linkage arm 102, respectively. East bladder assembly 189 includes east bladder 112, east bladder cover 185 and bladder attachment 187. West bladder assembly 188 includes west bladder 110, west bladder cover 186 and bladder attachment 187. Bladders 112, 110 form a flexible container for a fluid such as water or other fluid having a low viscosity. Bladders 110, 112 are generally made of a malleable material, for example rubber, such that bladders 110, 112 may compress or collapse when they come into contact with a solid object. The material of bladders 110, 112 should also be strong enough to hold a volume of fluid without tearing or rupturing. Alternatively, bladders 110, 112 may be made of a material formed in a pleated shape and is thereby compressible. In another embodiment, bladders 110, 112 may be formed of slidable concentric, telescoping, or otherwise nested sections, such that the sections may slide relative to one another to change the volume of bladders 110, 112.

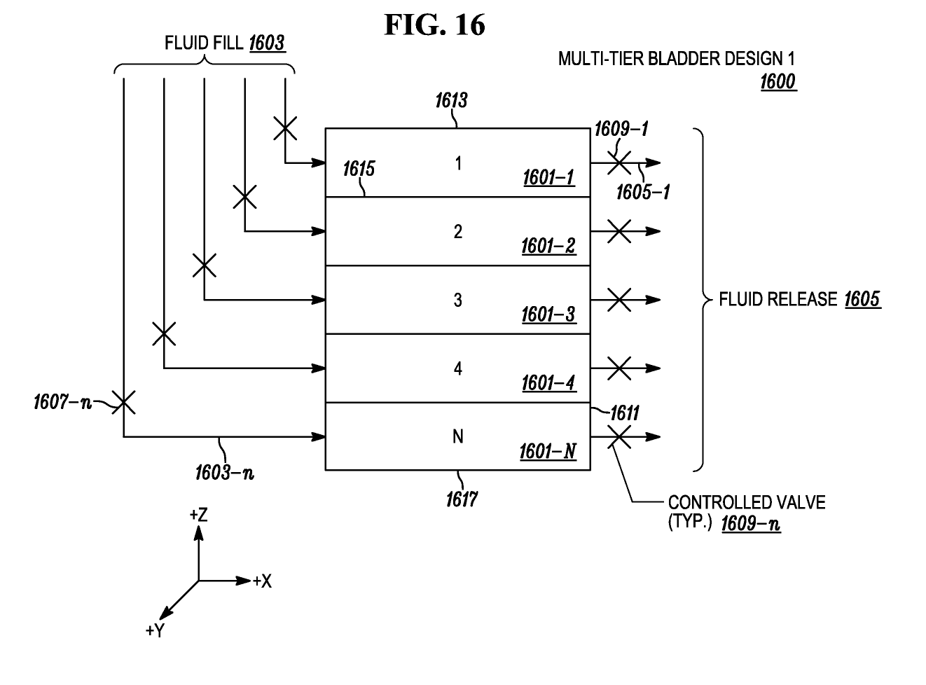

In some embodiments, one or both of bladders 110, 112 may include a plurality of chambers configured to store and discharge fluid, as described below in further detail with respect to FIGS. 16-19A,B.

Bladder cover 185, 186 is coupled to a respective bladder 112, 110 such that the respective bladder is suspended beneath the respective cover. Bladder covers 185, 186 may include a substantially rigid material forming at least a top major surface and a bottom major surface, the bottom major surface configurable to press down onto respective bladder 112, 110 and its contents when a weight or other downward pressure is applied to the respective bladder cover 185, 186.

Bladder assembly 188, 189 may include a respective sealable ingress port 134, 136 operable to permit a fluid such as water to enter respective bladder 110, 112. In some embodiments, the ingress port 134, 136 may take the form of a sealable aperture running between a top major surface to a bottom major surface of respective bladder cover 185, 186. In other embodiments, the ingress port 134, 136 may take the form of a fill tube having one end coupled to respective bladder 110, 112 and having a second end configurable to be coupled to a fluid source or reservoir. In another embodiment, the ingress port 134, 136 may be a sealable aperture of bladder 110, 112 that is configurable to accept a fill tube through which fluid may be delivered to bladder 110, 112. In another embodiment, one or both of ingress port 134, 136 may be continuously coupled to respective discharge pipe 126, 128 by use of a flexible, sealed tube having sufficient slack and flexibility to accommodate linkage 102 during its full range of motion, such as rubber, plastic, or any other material known to a person of ordinary skill in the art, similar to transfer pipes 118 and 120. When the power generation system 100 is not in operation, discharge pipes 126 and 128 if sealed may be disconnected from bladders 110 and 112 for maintenance or any other purposes. Other configurations for ingress port 134, 136 are contemplated.

Power generation system 100 includes a west weight assembly 183 and an east weight assembly 182. West weight assembly 183 is connected to the west end of linkage 102 by bladder attachment 187, and east weight assembly 182 is connected to the east end of linkage 102 by bladder attachment 187. Weight assembly 183, 182 includes a respective weight 106, 108. The weights 106 and 108 are of equal weight and may be any weight that can be supported by the linkages 102 and 104. The weights 106 and 108 may be in any form capable of amassing the desired weight. For example, the weights 106 and 108 may be in a solid, rigid form, such as a steel block, or in loose, flowable form, such as water, sand, etc., in which case it may be housed in a container.

Each weight assembly 183, 182 may further include a first attachment mechanism 179 and a second attachment mechanism 178. First attachment mechanism 179 is configured to be detachably coupled to a stand such as stand 181 or stand 180. Second attachment mechanism 178 is configured to be detachably coupled to a bladder cover such as bladder cover 185 or 186. Attachment mechanisms 179, 178 may include, for example, a solenoid or the like, which couples and decouples with conforming receptacles in bladder cover 186 and stand 181 (or bladder cover 185 and stand 180). In some embodiments, attachment mechanisms 179, 178 may include separate rods and solenoids, whereas in other embodiments, attachment mechanisms 179, 178 may include a rod and solenoid configured to function as both attachment mechanisms 179 and 178. Weight assembly 183, 182 is described in further detail below.

Stand 180, 181 may take different forms or shapes than that shown in FIG. 1. For example, stand 180, 181 may have a U-shaped cross-sectional shape in a horizontal plane, such that respective weight 108, 106 is substantially but not entirely encircled by respective stand 180, 181.

West bladder 110 is connected to east reservoir 116 via transfer pipe 118, and east bladder 112 is connected to west reservoir 114 via transfer pipe 120. The respective connections may be sealed to air or may be open air as illustrated in FIG. 1. A sealed connection may help reduce evaporation. A support 176 may be provided to help maintain proper orientation of transfer pipe 118, 120 with respective reservoir 116, 114. The transfer pipes 118 and 120 should generally be a flexible material, such as rubber or plastic tubing or conduit, so that transfer pipes 118, 120 may move in conjunction with the bladders 110 and 112 when the power generation system 100 is in operation. A highly pliable material for transfer pipes 118, 120 will lessen resistance to motion of respective bladder assemblies 188, 189. The material of the transfer pipes 120 and 118 should also generally have a low coefficient of friction to minimize losses due to frictional forces when the power generation system 100 is in operation. The material may be any material known to a person of ordinary skill in the art that generally meet the properties described above. The diameter of transfer pipe 118, 120 may be relatively small in order to lessen the amount of fluid within transfer pipe 118, 120 at any given time. Alternatively, the diameter of transfer pipe 118, 120 may be relatively larger in order to support a faster transfer of fluid.

In some embodiments in accordance with the present invention, fluid exiting transfer pipe 118, 120 may drop into respective reservoirs 116, 114 as illustrated in FIG. 1. In other embodiments in accordance with the present invention, transfer pipe 118, 120 may be coupled to respective reservoirs 116, 114 by a sealed interface. If a sealed interface is provided, air venting may be provided for reservoirs 116, 114.

Backflow preventers 122 and 124 are located near the connection points between the respective bladders and transfer pipes. The backflow preventers 122 and 124 ensure that fluid does not flow back into the bladders 110 and 112, thereby inhibiting the operation of the power generation system 100. The backflow preventers 122 and 124 may be any kind of check valve, or any other backflow prevention device known to a person of ordinary skill in the art.

The reservoirs 114 and 116 are positioned at substantially the highest point of the power generation system 100. The reservoirs 114 and 116 may be any size and shape, such as a cube, cylinder, sphere, etc., capable of holding a volume of fluid. Generally, the volume of the reservoirs 114 and 116 will be greater than the volume of the bladders 110 and 112. The reservoirs 114 and 116 may be made of a substantially rigid material, such as metal, plastic, glass, and the like, such that the shape will be constantly maintained, or may alternatively be a flexible material, a pleated material, or constructed of slidable concentric, telescoping, or otherwise nested sections. FIG. 1 illustrates a fluid level 177a, 177b within respective reservoirs 114, 116 if reservoirs 114, 116 are made of a substantially rigid material.

In some embodiments in accordance with the present invention, reservoir 114, transfer pipe 120 and bladder 112 may form a first substantially sealed assembly. Reservoir 116, transfer pipe 118 and bladder 110 may form a second substantially sealed assembly. In some embodiments for which ingress port 134, 136 may be continuously coupled to respective discharge pipe 126, 128 by use of a flexible, sealed reservoir transfer tube, reservoir 114, transfer pipe 120, bladder 112, reservoir 116, transfer pipe 118, bladder 110, and respective reservoir transfer tubes may form a sealed assembly.

The reservoirs 114 and 116 may each include a discharge pipe 126 and 128, respectively, through which fluid from the reservoirs 114 and 116 may flow into the bladders 110 and 112, respectively, when the power generation system 100 is in operation. The discharge pipes 126 and 128 may be made of a rigid material, such as copper, steel, iron, plastic, PVC, glass, and the like, or of a flexible material, similar to the transfer pipes 118 and 120.

The flow of the fluid from the reservoirs 114 and 116 to the bladders 110 and 112, respectively, may be controlled by valves 130 and 132, respectively. The valves 130 and 132 may be any valve known to a person of ordinary skill in the art, such as a gate valve, ball valve, globe valve, etc. The valves 130 and 132 may further be controlled either manually or automatically, as with a motor actuator, pneumatic actuator, solenoid, or any other automatic control device known to a person of ordinary skill in the art. Any power used to actuate valves 130, 132 is derived from a power source that is independent and/or self-contained from the power harvested by hub 190, such as a battery.

The bladders 110 and 112 may be connected to the discharge pipes 126 and 128, and ultimately to the reservoirs 114 and 116, via ingress port 134 and 136, respectively. Ingress port 134 and 136 may include a latch, magnet, or any other device known to a person of ordinary skill in the art that may securely attach the bladders 110 and 112 to the discharge pipes 126 and 128, respectively. The connection devices 134 and 136 may be configurable to maintain a connection after the bladders 110 and 112 are filled with fluid. The ingress ports 134 and 136 should be configured such that fluid should not leak when flowing from the reservoirs 114 and 116 to the bladders 110 and 112, respectively, when the power generation system 100 is in operation. The ingress port 134 and 136 may further comprise a mechanism to disengage the connection, such as a solenoid and the like, during operation of the power generation device 100. Any power used to disengage ingress port 134, 136 is derived from a power source that is independent and/or self-contained from the power harvested by hub 190, such as a battery.

While not shown in FIG. 1, the reservoirs 114 and 116 may each further comprise an air vent to bleed out air that has entered the system. The air vent may be automatic or manual. It will be apparent to a person of ordinary skill in the art how to implement any other known devices or methods to bleed out air from the system. Any power used to automatically operate an air vent is derived from a power source that is independent and/or self-contained from the power harvested by hub 190, such as a battery.

The power generation system 100 may further comprise two stationary contact components 138 and 140 that engage with the bladders 110 and 112, respectively, when the power generation system 100 is in operation. The contact components 138 and 140 may be any object and any material capable of causing the bladders 110 and 112, when filled with fluid, to collapse or compress when they come into contact with the contact components 138 and 140. For example, they may be solid blocks, as depicted in FIG. 1. Alternatively, there may be no contact components 138 and 140, in which scenario the bladders 110 and 112 may engage with a surface such as the floor.

In some embodiments, contact components 138, 140 may include a cavity configured to receive bladders 110, 112 when bladders 110, 112 are filled with fluid, and to constrain any ballooning as bladders 110, 112 are emptied. In some embodiments, the interior cross-sectional area of the cavity is large enough to accommodate the cross-sectional area of bladder covers 186, 185.

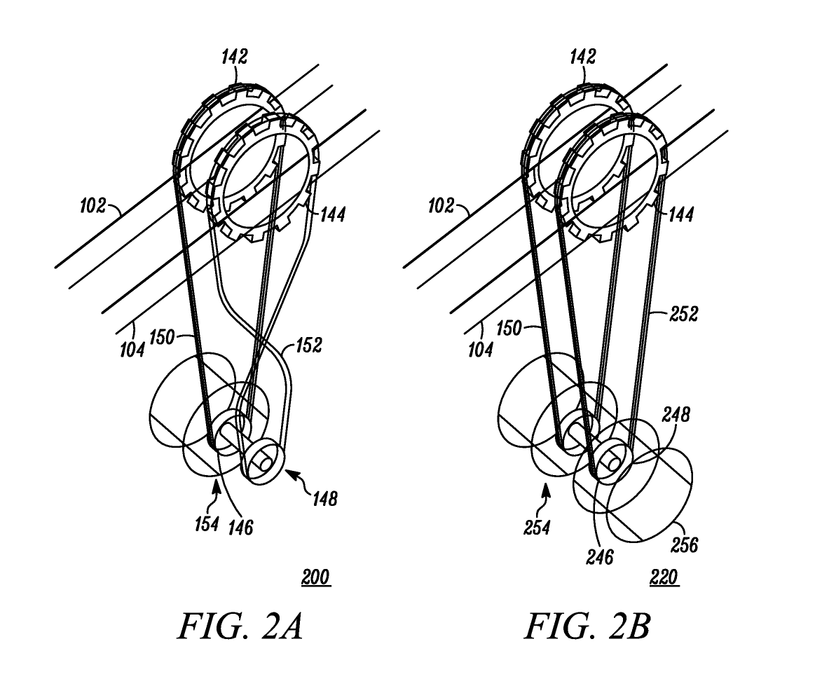

FIG. 2A illustrates an embodiment 200 of a subassembly that may be used, as a hub 190, in order to harvest the pivot action of linkage 102 into rotary mechanical power, and from there to electrical power. The harvesting mechanism may include, for example, a gear and chain system positioned at hub 190. The gear and chain system includes drive gears 142 and 144, transfer gears 146 and 148, a chain 150 and a reversed chain 152. The shaft connecting drive gears 142, 144 is also connected to the linkage 102 and to optional linkage 104 (if present) such that when the linkages are in motion, the shaft, and in turn the drive gears 142 and 144, will rotate.

Chain 150 connects the drive gear 142 and the transfer gear 146, and the reversed chain 152 connects the drive gear 144 and the transfer gear 148. It should be understood by a person of ordinary skill in the art that the chain 150 and reversed chain 152 may be any object capable of translating the rotational motion of the drive gears 142 and 144 to the transfer gears 146 and 148. For example, the chain 150 and reverse chain 152 may be belts. The transfer gears 146 and 148 are freewheel gears such that each will engage with the shaft connecting them when they rotate in a certain direction only. Only one transfer gear 146 or 148 will engage per direction.

The shaft connecting the transfer gears 146 and 148 is further connected to an energy converter 154, which converts the rotational or kinetic energy created by the power generation system 100 when in operation to electricity. The energy converter may be an alternator, motor, electric generator, or any other energy conversion device known to a person of ordinary skill in the art.

FIG. 2B illustrates an embodiment 220 of a subassembly that may be used, as a hub 190, in order to harvest the pivot action of linkage 102 into rotary mechanical power, and from there to electrical power. A difference compared to embodiment 200 is that embodiment 200 includes two energy converters 254 and 256, whereas embodiment 200 includes only a single energy converter 154. For this reason, chain 252 is not reversed.

Operation of a cycle of power generation system 100 will now be described, in accordance with an embodiment of the present invention. Suppose a starting point as show in FIG. 1, in which fluid within reservoir 116 is about to drain into bladder 112. Discharge pipe 128 is about to be reconnected with ingress port 136 if so configured to be separable. Bladder 112 is at a high position and is substantially empty. Bladder 110 is at a low position. Weight 106 is engaged with bladder cover 186 via second attachment mechanism 178. First attachment mechanism 179 is retracted, therefore weight 106 is shown as not coupled to stand 181. Bladder 110 is engaged with contact component 138, is in a compressed state, and is substantially empty with a minimal amount of fluid. Weight 108 is supported by stand 180 at a high position. Alternatively, the startup position may be with bladder 110 connected to reservoir 114, and bladder 112 engaged with contact component 140.

Power generation system 100 includes at least enough fluid to fill one of bladders 110, 112, plus transfer pipes 118, 120. Additional fluid in power generation system 100, if present, may be located in reservoir 114, 116, or as residual fluid in a compressed bladder. The fluid is circulated between bladder 112, reservoir 114, bladder 110 and reservoir 116 in order to generate power. The fluid may be any fluid, such as water. However, the fluid should generally have a low viscosity. The level of the fluid in the reservoirs 114 and 116 should be above the point where discharge pipes 126, 128 allow the fluid to flow by gravity through ingress port 134, 136 into bladder 110, 112. As explained above, the backflow preventers 122 and 124 prevent the fluid from flowing into the bladders 110 and 112. In addition, reservoir 116 may have an additional volume of fluid, such that reservoirs 114, 116 are not completely empty after respective bladders 110, 112 are filled. For example, when the fluid discharges from the reservoir 116 into bladder 112, the level of the fluid in reservoir 116 may still be above the connection point of transfer pipe 120. The additional volume of fluid may be helpful to prevent air from entering discharge pipes 126, 128.

The operation of the power generation system 100 begins when valve 132 opens, allowing the fluid to flow by gravity from reservoir 116 into bladder 112. When bladder 112 is filled with the fluid, valve 132 will close. As explained above, valve 132 may be opened and closed either manually or automatically. Bladder 112 may include a level switch (e.g., a float, moisture sensor, etc.) inside bladder 112 that signals valve 132 to close when the fluid reaches a certain level. Alternatively, valve 132 may be controlled based upon sensing how much fluid has drained from reservoir 116. Alternatively, the duration of time that valve 132 is in the open position may be predetermined and controlled by a timer. The duration of time may be adjustable. It should be understood by a person of ordinary skill in the art that any known methods or devices to control when the valve 132 should close may be implemented. In any of these scenarios, a signal will be sent to valve 132, either from the level switch or the timer, via a microprocessor, or manually. At the same time, another signal will be sent from the microprocessor to discharge pipe 128 and/or ingress port 136, causing the discharge pipe 128 and ingress port 136 to disengage with each other. If discharge pipe 128 and ingress port 136 are not designed to disengage (i.e., if they are connected by a sealed tube), a locking mechanism (not illustrated) may be used to keep bladder 112 in a preferred position until after it is full enough to descend. Upon the initial descent, the weight of full bladder assembly 189 is greater than the sum weight of empty bladder assembly 188 plus weight assembly 183.

Any power used to actuate a level switch, timer, microprocessor or other active devices is derived from a power source that is independent and/or self-contained from the power harvested by hub 190, such as a battery.

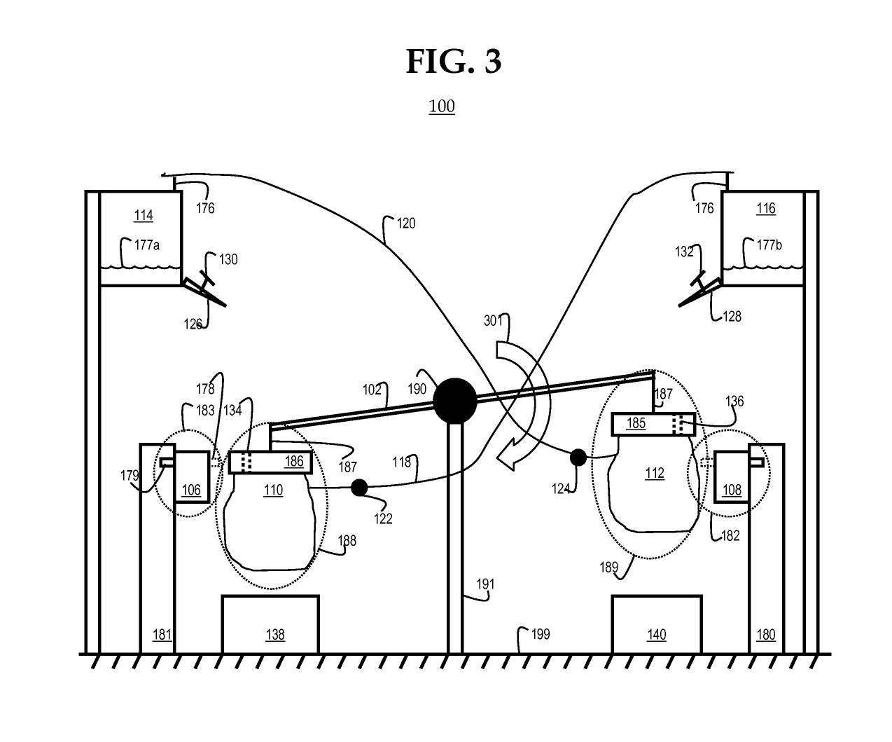

When bladder 112 begins descending, bladder 110 begins ascending. Linkage 102 initially begins pivoting in a clockwise direction. Referring now to FIG. 3, power generation system 100 is illustrated during a point in this motion 301. In particular, the point illustrated in FIG. 3 is when west bladder assembly 188 has risen to a predetermined position with respect to stand 181, specifically to a point at which west weight assembly 183 has been offloaded to stand 181. In FIG. 3, second attachment mechanism 178 has disengaged from bladder cover 186, and first attachment mechanism 179 has engaged with stand 181. Note that east bladder assembly 189 is not engaged with east weight assembly 182. At this point, since the weight of east bladder assembly 189 (including full bladder 112) is greater than west bladder assembly 188 with empty bladder 110, clockwise motion 301 continues but with greater force than when weight assembly 183 had been coupled to bladder assembly 188.

As the east side of the power generation system 100 descends and the west side ascends, the potential energy created from the initial height of the weight 108 and bladder 112 combination is converted into kinetic energy.

As the east side is descending and the west side is ascending, the clockwise motion will cause the drive gears 142 and 144 to rotate via their shaft. As explained above, this rotational motion is transferred to the transfer gears 146 and 148 via the chain 150 and/or the reversed chain 152. While transfer gear 148 will be rotating in the opposite direction as transfer gear 146 due to the reversed chain 152, because the transfer gears 146 and 148 are freewheel gears, transfer gear 148 will disengage from the drive shaft when rotating in this direction, and therefore, will have no effect on the rotation of the shaft generated from the rotation of transfer gear 146. As the power generation system 100 is in motion, and the shaft connecting the transfer gears 146 and 148 is rotating, the energy created from the rotation of the shaft is transferred to the energy converter.

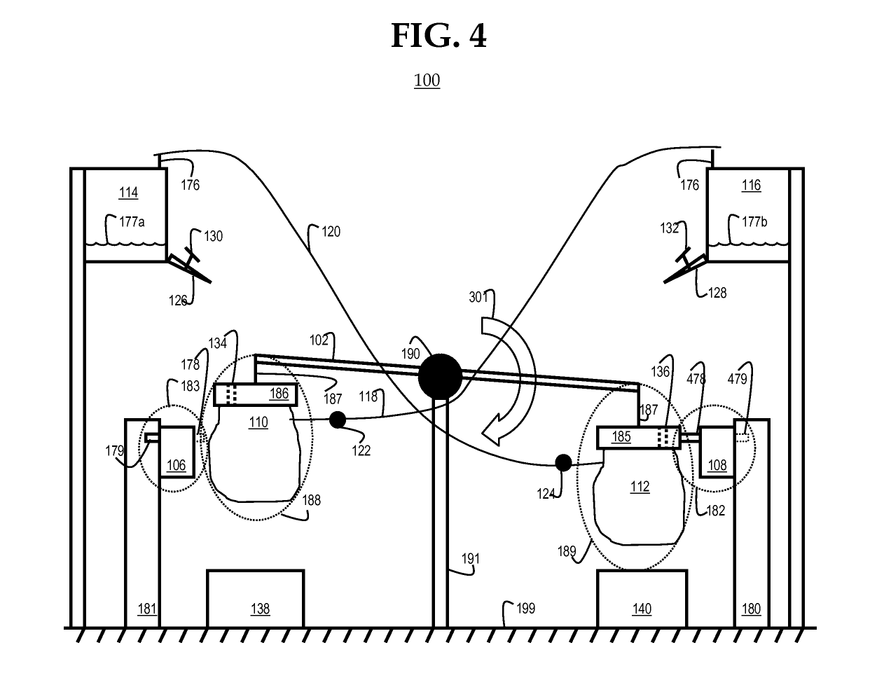

Next, FIG. 4 illustrates power generation system 100 during a further point in motion 301. Linkage 102 has further rotated in a clockwise direction compared to FIG. 3. In particular, linkage 102 has rotated to a point at which bladder assembly 189 is aligned with weight assembly 182 such that support of weight assembly 182 has been transferred from stand 180 to bladder assembly 189. For example, as illustrated in FIG. 4, first east attachment mechanism 479 has disengaged from stand 180, and second east attachment mechanism 478 has engaged with east bladder cover 185. Preferably, the transfer of support of weight assembly 182 is accomplished with reduced loss of kinetic motion of linkage 102. However, even if linkage 102 stops rotating during the transfer of support of weight assembly 182, the additional weight provided by weight assembly 182 is adequate to restart clockwise motion.

In some embodiments in accordance with the present invention, FIGS. 3 and 4 may be combined if stands 180, 181 are sufficiently tall. For example, if stands 180, 181 are at least as tall above support surface 199 as hub 190, then the transfer of weight 108 from bladder assembly 189 to stand 180, and the transfer of weight 106 from stand 181 to bladder assembly 188, may be accomplished at about the same time.

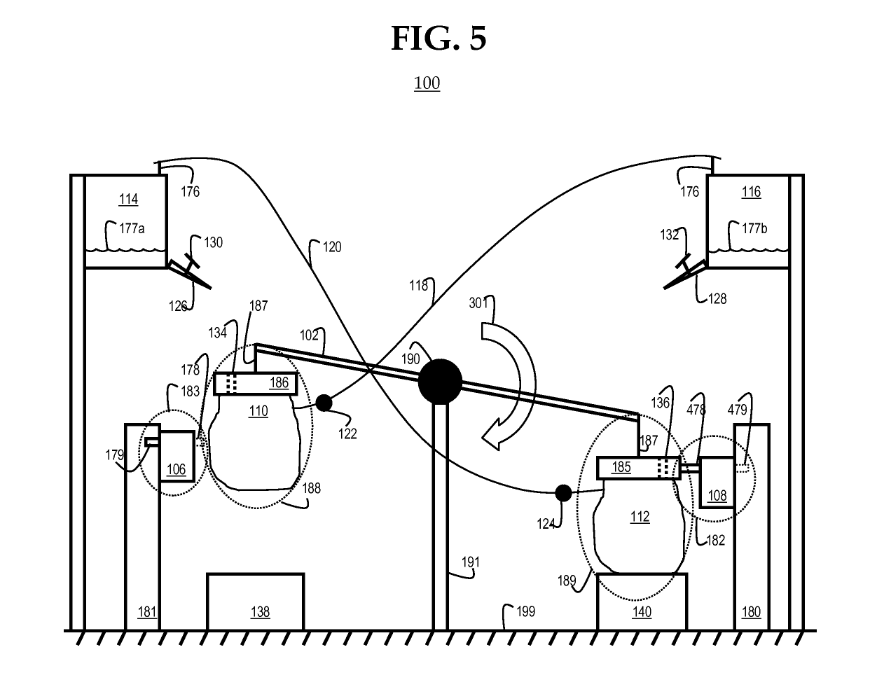

Next, FIG. 5 illustrates power generation system 100 during a further point in motion 301. Linkage 102 has further rotated in a clockwise direction compared to FIG. 4. In particular, linkage 102 has rotated to a point at which bladder 112 has begun to come into contact with contact component 140. Bladder 112 is squeezed by the weight of weight assembly 182. As this occurs, the combined effect of pressure exerted by the weight of weight assembly 182 and the kinetic energy of bladder assembly 189 forces fluid in bladder 112 into the transfer pipe 120, thereby displacing the same volume of fluid in the transfer pipes into the reservoir 114. Backflow preventer 124 will control the flow of the fluid in a single direction from the bladder 112 to the reservoir 114. The amount of downward force that must be exerted by the weight of weight assembly 182 must be sufficient to overcome the weight of fluid within transfer pipe 120 when backflow preventer 124 is opened. Since the diameter (and thus volume) of transfer pipe 120 may be made arbitrarily small, the commensurate force is also arbitrarily small but at a cost of increased fluid transfer time. As bladder 112 continues to be squeezed, fluid in transfer pipe 120 continually flows into reservoir 114 and is replaced in transfer pipe 120 with fluid from bladder 112. Weight will continue to be applied until bladder 112 is substantially empty of fluid.

Contact component 140 may be shaped with a cavity generally conforming to the size, volume and/or shape of bladder 112, such that ballooning of bladder 112 is mitigated as pressure is applied by weight assembly 182. If contact component 140 includes a cavity, vertical slots may be provided along a side of contact component 140 in order to permit movement of second attachment mechanism 478 below the level of the top of contact component 140.

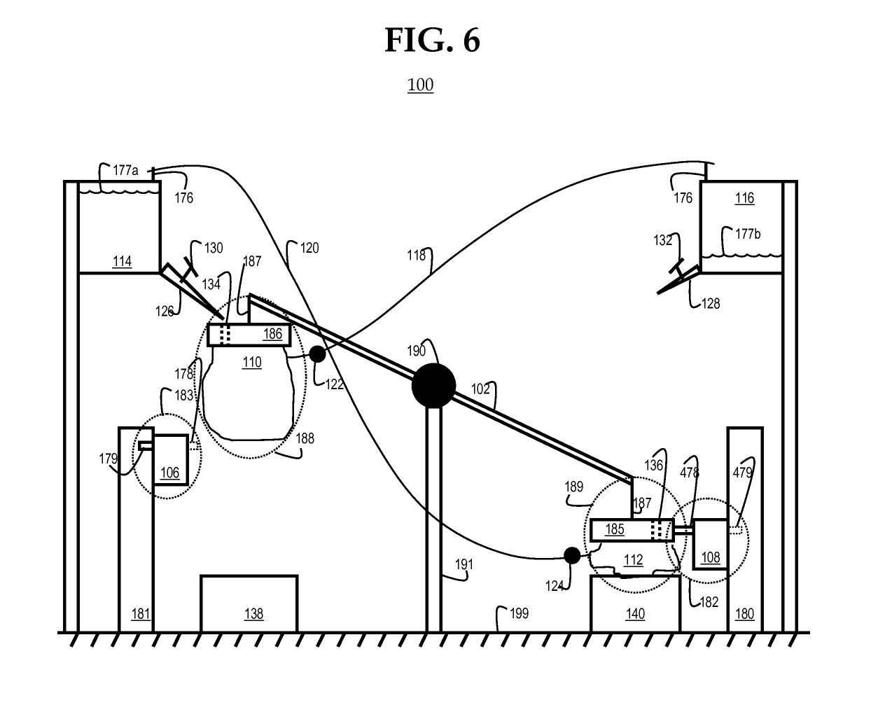

Next, FIG. 6 illustrates power generation system 100 upon completion of motion 301. Linkage 102 has further rotated in a clockwise direction compared to FIG. 5. In particular, linkage 102 has rotated to a point at which bladder 112 is substantially empty, and the fluid that had been within it has been transferred to transfer pipe 120 and reservoir 114. After this occurs, bladder 110 will attach to reservoir 114 via the discharge pipe 126 and connection device 134. At this point, valve 130 will open, allowing fluid from reservoir 114 to flow into bladder 110 through the discharge pipe 126 and connection device 134. As with valve 132, valve 130 may be operated either manually or automatically. When bladder 110 had attached to reservoir 114, a signal may have been sent to an actuator controlling valve 130, commanding it to open. Alternatively, the actuator may have been set to open based on a predetermined time dependent upon the duration of time it takes the power generation system 100 to go from its startup position depicted in FIG. 1 to its mirror position depicted in FIG. 6. It should be apparent to a person of ordinary skill in the art how to automatically control the valve 130 to open in other known ways.

As with valve 132, when bladder 110 is filled with fluid and/or reservoir 114 is substantially empty, valve 130 will close. Again, this may be performed either manually or automatically, where there may be a level switch inside bladder 110 that signals valve 130 to close, or the duration of time that valve 130 is in the open position may be predetermined and controlled by a timer. A signal may be sent to valve 130 via a microprocessor. At about the same time, another signal may be sent from the microprocessor to the connection device 134, causing it to release, thereby initiating the descent of bladder 110 and the ascent of bladder 112.

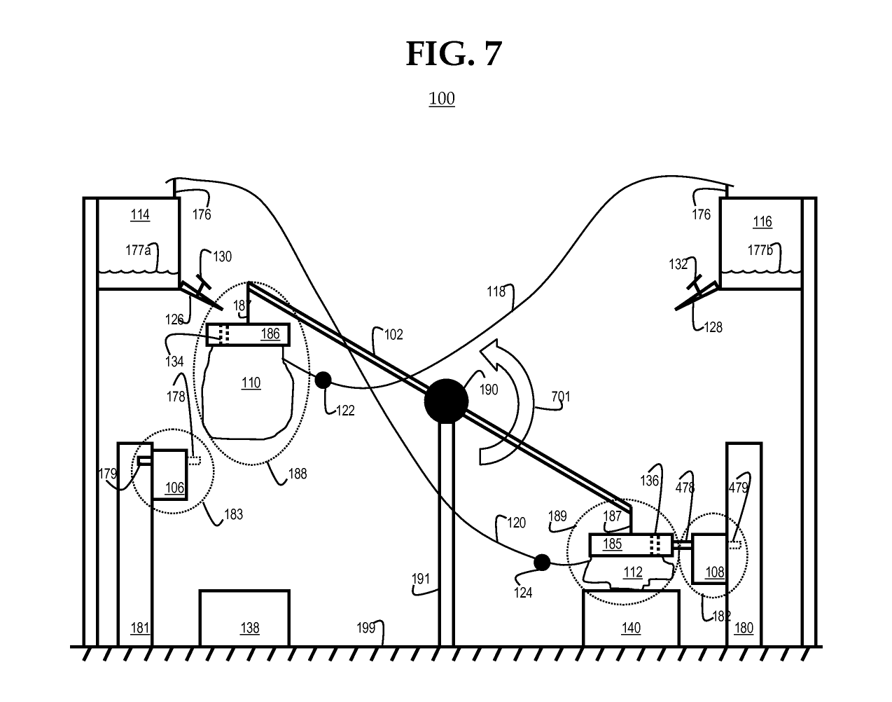

Next, FIG. 7 illustrates power generation system 100 as it has begun a counter-clockwise motion 701. Bladder 110 is substantially full and reservoir 114 is substantially empty. Discharge pipe 126 has disengaged from connection device 134 except in embodiments in which discharge pipe 126 and connection device 134 are permanently joined in a flexible, sealed connection throughout the completion of the clockwise and counter-clockwise cycle.

The drive gears will now be rotating in the opposite direction than in the stage of operation depicted in FIGS. 3-5. In this stage of operation, the transfer gear 148 will control the rotation of the shaft, and transfer gear 146 will be disengaged with the shaft. This allows for energy generated by both the clockwise and counter-clockwise motion of the power generation system 100 to be used or stored.

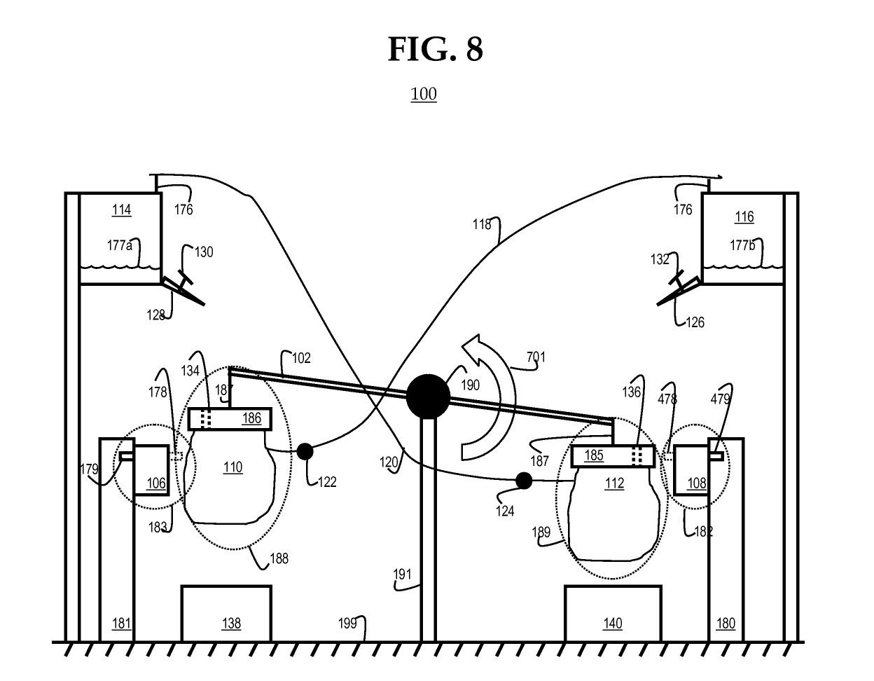

Next, FIG. 8 illustrates power generation system 100 is illustrated during a further point in counter-clockwise motion 701. In particular, the point illustrated in FIG. 8 is when east bladder assembly 189 has risen to a predetermined position with respect to stand 180, specifically to a point at which east weight assembly 182 has been offloaded to stand 180. In FIG. 8, second attachment mechanism 478 has disengaged from bladder cover 185, and first attachment mechanism 479 has engaged with stand 180. Note that west bladder assembly 188 is not engaged with west weight assembly 183. At this point, since the weight of west bladder assembly 188 (including full bladder 110) is greater than east bladder assembly 189 with empty bladder 112, counter-clockwise motion 701 continues but with greater force than when weight assembly 182 had been coupled to bladder assembly 189. FIG. 8 is essentially a mirror image of FIG. 3.

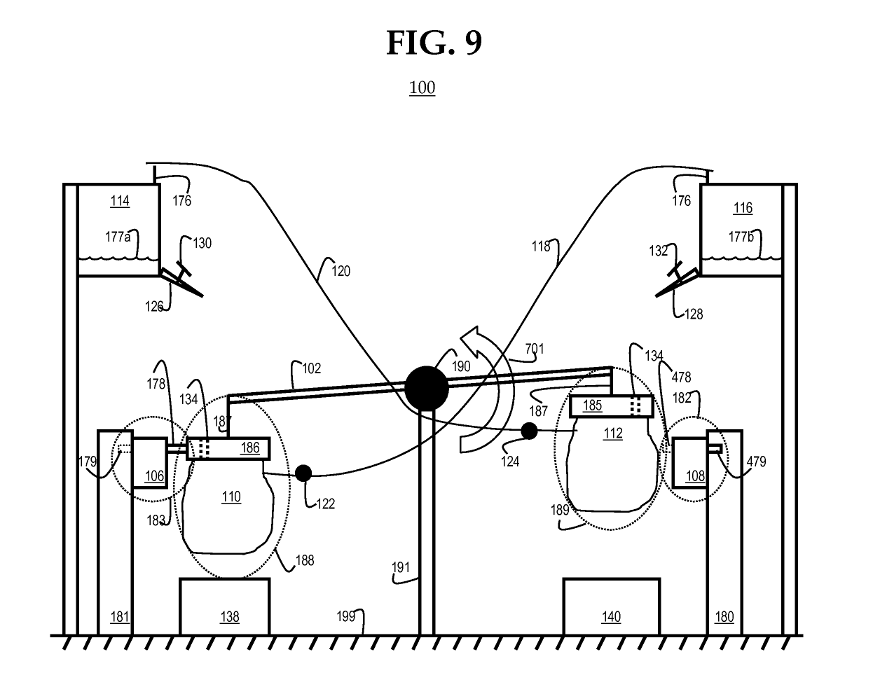

Next, FIG. 9 illustrates power generation system 100 during a further point in motion 701. Linkage 102 has further rotated in a counter-clockwise direction compared to FIG. 8. In particular, linkage 102 has rotated to a point at which bladder assembly 188 is aligned with weight assembly 183 such that support of weight assembly 183 has been transferred from stand 181 to bladder assembly 188. For example, as illustrated in FIG. 9, first west attachment mechanism 179 has disengaged from stand 181, and second west attachment mechanism 178 has engaged with west bladder cover 186. Preferably, the transfer of support of weight assembly 183 is accomplished in a way that mitigates loss of kinetic motion of linkage 102. However, even if linkage 102 stops rotating during the transfer of support of weight assembly 183, the additional weight provided by weight assembly 183 is adequate to restart counter-clockwise motion. FIG. 9 is essentially a mirror image of FIG. 4.

In some embodiments in accordance with the present invention, FIGS. 8 and 9 may be combined if stands 180, 181 are sufficiently tall. For example, if stands 180, 181 are at least as tall above support surface 199 as hub 190, then weights 106, 108 may be transferred at about the same time during the counter-clockwise cycle of motion as described above during the clockwise cycle of motion.

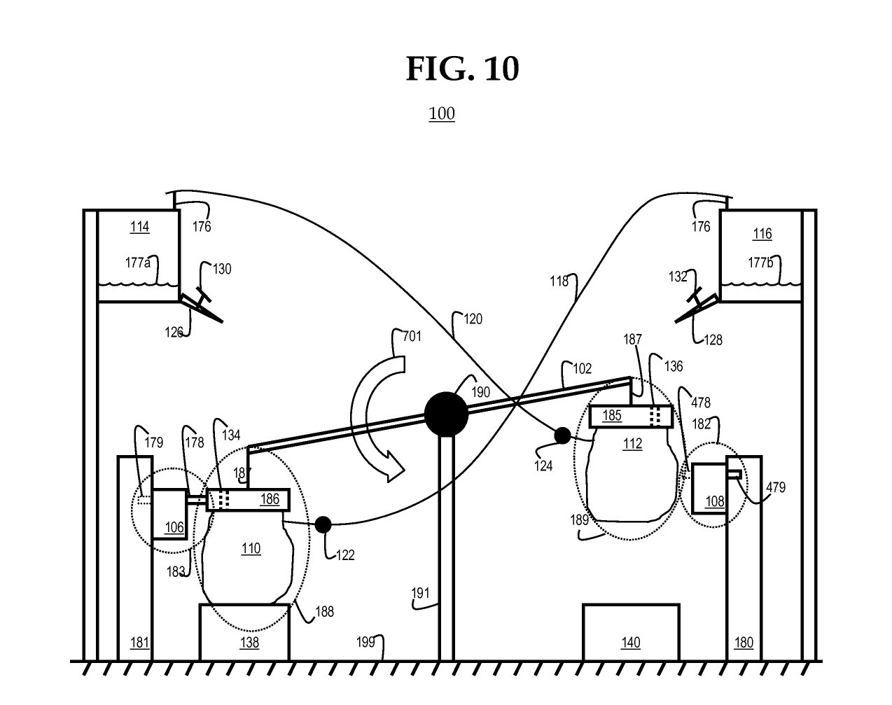

Next, FIG. 10 illustrates power generation system 100 during a further point in motion 701. Linkage 102 has further rotated in a counter-clockwise direction compared to FIG. 9. In particular, linkage 102 has rotated to a point at which bladder 110 has begun to come into contact with contact component 138. As this occurs, the combined effect of pressure exerted by the weight of weight assembly 183 and the kinetic energy of bladder assembly 188 forces fluid in bladder 110 into the transfer pipe 118, thereby displacing the same volume of fluid in transfer pipe 118 into the reservoir 116. Backflow preventer 122 will control the flow of the fluid in a single direction from the bladder 110 to the reservoir 116. The amount of downward force that must be exerted by the weight of weight assembly 183 must be sufficient to overcome the weight of fluid within transfer pipe 118 when backflow preventer 122 is opened. Since the diameter (and thus volume) of transfer pipe 118 may be made arbitrarily small, the commensurate force is also arbitrarily small. Weight will continue to be applied until bladder 110 is substantially empty of fluid. FIG. 10 is essentially a mirror image of FIG. 5.

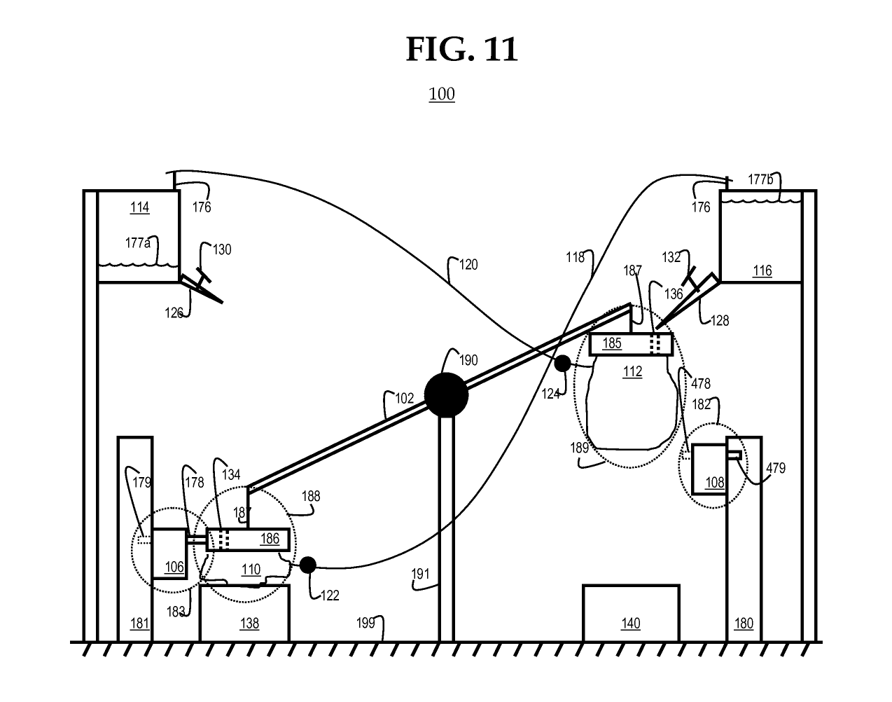

Next, FIG. 11 illustrates power generation system 100 upon completion of motion 701. Linkage 102 has further rotated in a counter-clockwise direction compared to FIG. 10. In particular, linkage 102 has rotated to a point at which bladder 110 is substantially empty, and the fluid that had been within it has been transferred to transfer pipe 118 and reservoir 116. After this occurs, bladder 112 will attach to reservoir 116 via the discharge pipe 128 and connection device 136. At this point, valve 132 will open, allowing fluid from reservoir 116 to flow into bladder 112 through the discharge pipe 128 and connection device 136. As with valve 130, valve 132 may be operated either manually or automatically. When bladder 112 had attached to reservoir 116, a signal may have been sent to an actuator controlling valve 132, commanding it to open. Alternatively, the actuator may have been set to open based on a predetermined time dependent upon the duration of time it takes the power generation system 100 to go from its startup position depicted in FIG. 7 to its mirror position depicted in FIG. 11. It should be apparent to a person of ordinary skill in the art how to automatically control the valve 132 to open in other known ways. FIG. 11 is essentially a mirror image of FIG. 6.

FIG. 1 and FIGS. 3-11 form a complete cycle of motion of power generation system 100. This cycle repeats indefinitely, during which energy is harvested at hub 190.

Power generation system 100 operates in a slightly different manner when hub 190 is implemented as embodiment 220 of FIG. 2B rather than embodiment 200 of FIG. 2A. Because there are two energy converters 254 and 256, chain 252 does not have to be reversed. When bladder 112 is descending and bladder 110 is ascending, the rotational energy created by the rotation of transfer gear 246 will be converted to electricity by energy converter 254. Because transfer gear 248 is a freewheel gear, it will rotate in the same direction but will have no effect on the transfer of energy to energy converter 254. When bladder 110 is descending and bladder 112 is ascending, the rotational energy created by the rotation of transfer gear 248, which will be the opposite direction, will be converted to electricity by energy converter 256. Because transfer gear 246 is also a freewheel gear, it will rotate in the same direction but will have no effect on the transfer of energy to energy converter device 256.

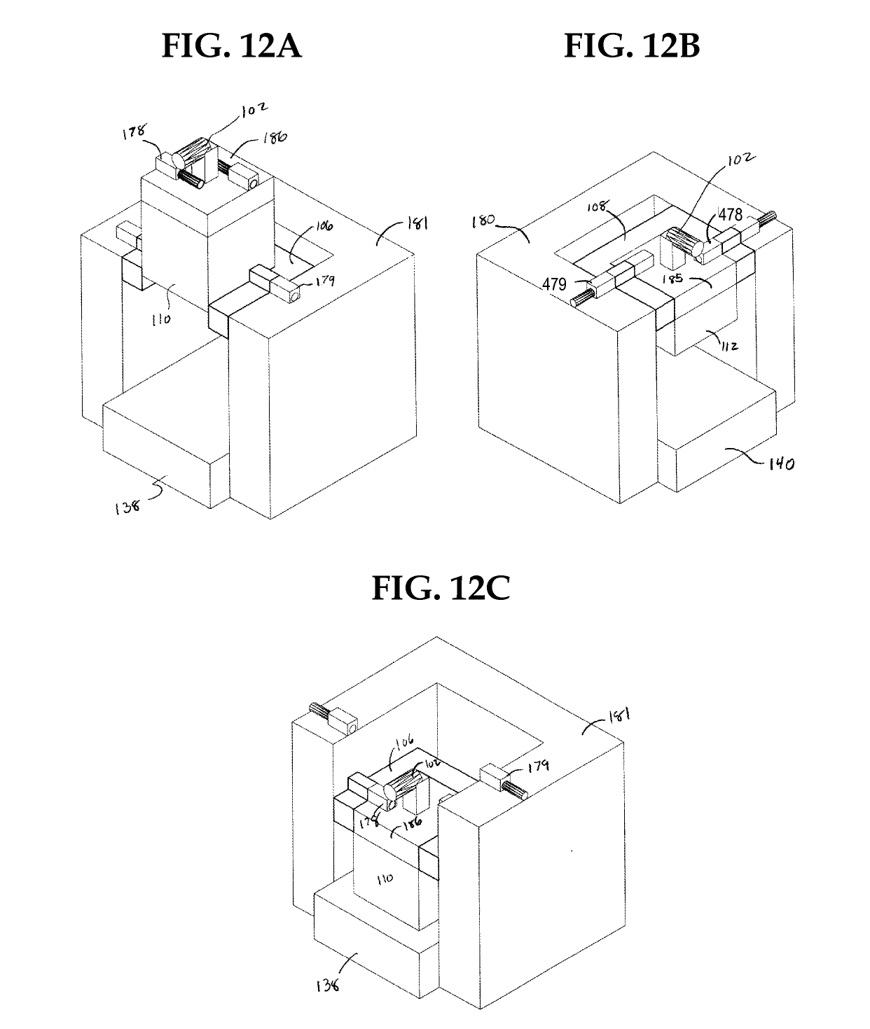

FIG. 12A-C illustrate embodiments of stand 180, 181, components of respective weight assemblies 182, 183, components of respective bladder assemblies 189, 188 and respective contact components 140, 138 in accordance with an embodiment of the present invention. East and west components are essentially mirror images of each other.

FIG. 12A illustrates a point during operation when components of west bladder assembly 188 may be either descending to be adjacent to stand 181, or rising above stand 181. Bladder assembly 188 is supported by arm linkage 102, which is illustrated in FIGS. 12A-C in truncated view. The descending components are bladder 110, bladder cover 186, second attachment mechanism 178, and the illustrated end of arm linkage 102. Other components are stationary. Stand 181 supports weight 106.

FIG. 12B illustrates a point during operation when components of east bladder assembly 189 are at a point where weight 108 may be attached to, or detached from, east bladder assembly 189 depending upon where in the cycle the system is presently operating. Operation of the west bladder assembly 188 and west weight assembly 183 is substantially the same.

FIG. 12C illustrates a point during operation when components of west bladder assembly 188 are making contact with contact component 138. For example, on the downward cycle, FIG. 12C would illustrate the point at which bladder is being pressed downward by weight 106.

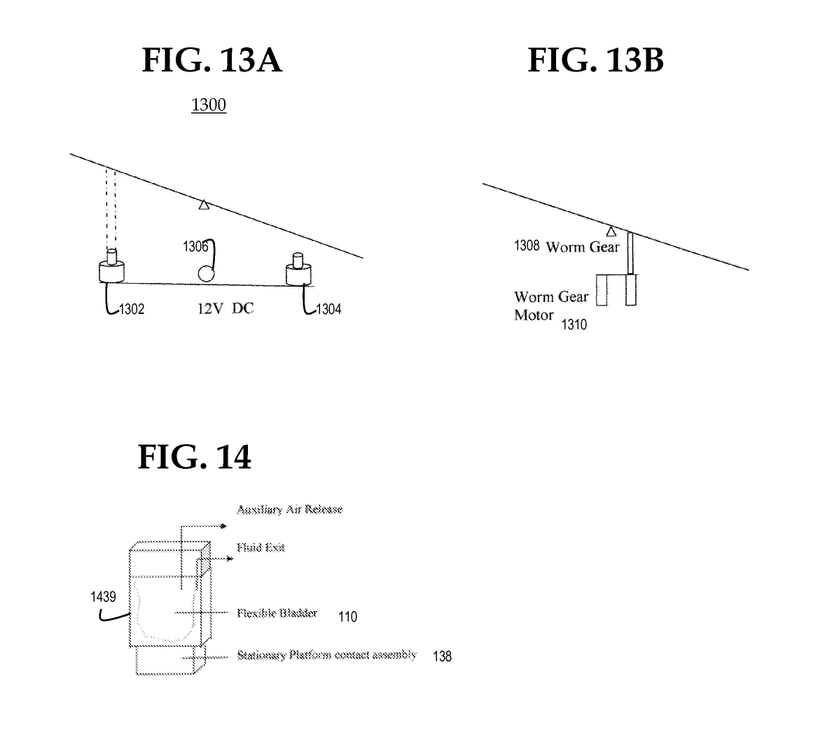

FIGS. 13A-B illustrate a reset device 1300 for resetting power generation system 100 to its startup position in accordance with an embodiment of the present invention. Due to the loss of energy from such external forces and conditions as friction, which may cause the power generation system to cease operating, system 100 may periodically need to be reset. This can be done by manually reattaching either bladder to its corresponding connection device.

Alternatively, the power generation system 100 may be automatically reset by first detecting that system 100 is no longer operating, and then initiating a device to reset system 100 to a predetermined startup position. An appropriate detector to detect a need for reset may include one or more motion sensors such that when the motion sensors no longer detect movement from system 100 for a set period of time, a signal will be sent to a controller, which will in turn send a signal to initiate reset device 1300. As another alternative, system 100 may include a current sensor or voltage meter such that when current or voltage is no longer being sensed or read, a signal will be sent to the controller, which in turn will send a signal to initiate reset device 1300. It will be clear to a person of ordinary skill in the art any known way to detect that the power generation system is no longer operating such that it will need to be reset may be implemented. In addition to sending a signal initiating reset device 1300, the controller may simultaneously send another signal opening a switch or contactor to disconnect the flow of power being used or stored downstream of the energy converter(s).

Reset device 1300 may include a west plunger 1302 and east plunger 1304, which extend and retract to an end of the linkages of the power generation system, and a motor 1306. The mechanism controlling the extension and retraction of each plunger 1302 and 1304 may include a worm gear 1308 and worm gear motor 1310 as illustrated in FIG. 13B. It should be apparent to a person of ordinary skill in the art how to implement any other device to control the extension and retraction of the plungers 1302 and 1304.

The power generation system 100 may include a level sensor or switch to determine which side of the system needs to be lifted. When it is detected that the system is not operating, a controller may send a signal to the starter of motor 1306, initiating the reset device 1300. Based on the level sensor, the motor will cause one of the plungers 1302 or 1304 to lift until it engages with the linkages of the power generation system. When the bladder is attached to the connection device such that the system is in its startup position, a signal will be sent to the reset device 1300 commanding the plunger 1302 or 1304 to retract, and to shutdown the motor 1306. Any power used to actuate reset device 1300 is derived from a power source that is independent and/or self-contained from the power harvested by hub 190, such as a battery, solar panel, wind turbine, etc.

It should be apparent to a person of ordinary skill how to implement any other known device to automatically reset the power generation system to its startup position.

In some embodiments in accordance with the present invention, one or both of bladders 110, 112 may include multiple compartments or sub-bladders. The sub-bladders may include separate inlet and/or outlet pipes that converge into the discharge pipes and transfer pipes of the power generation system 100. Each inlet and outlet pipe may further include its own valve, which may be controlled manually or automatically. This may allow for separate control of the filling and emptying of each sub-bladder.

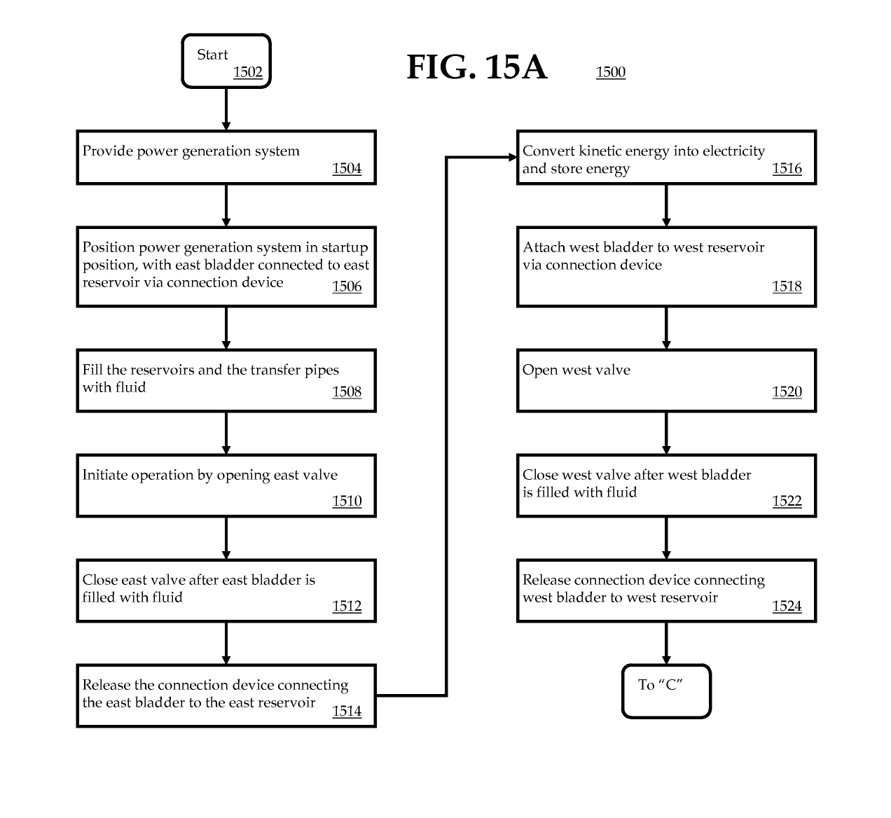

FIG. 14 illustrates an addition to the contact components of the power generation system 100. Contact component 138 may further include a control box 1439 (e.g., a stiff sleeve or the like) into which bladder 110 fits as it engages with the contact component 138. Specifically, the control box 1439 of contact component 138 controls the displacement of the bladder 110 when it is filled with fluid and begins to compress when it comes into contact with the contact component 138. This allows for better control of the transfer of fluid from the bladder 110 to the reservoir 116 via the transfer pipe 120. The control box may be any shape in which the bladders 110 and 112 may fit, but generally has a smaller volume than bladder 110 when full, but larger than bladder 110 when empty.

FIG. 16 illustrates a cross-sectional view in an XZ plane of multi-tier bladder 1600 in accordance with an embodiment of the present disclosure. Multi-tier bladder 1600 may be used for bladders 110, 112 depicted in FIG. 1. Multi-tier bladder 1600 includes a plurality of chambers 1601-1, 1601-2, 1601-3, 1601-4 . . . 1601-N, in which “N” is an integer greater than or equal to two. Chambers 1601-3, 1601-4 would not be present for N=2, and chamber 1601-4 would not be present for N=3. A single but unspecified chamber may be referred to herein as chamber 1601 or chamber 1601-n. The plurality of chambers may be referred to herein as chambers 1601. Chambers 1601 may be arranged in a generally vertical stack, with chamber 1601-n directly on top of chamber 1601-(n+1). Chambers 1601 may have a cross-sectional shape in the XY plane of substantially any shape, e.g., circular, oval, rectangular, square, or an arbitrary shape. Cross-sectional shapes of all chambers 1601 may be substantially the same as one another.

Chambers 1601 are enclosed by sidewalls 1611. Sidewalls 1611 may be constructed from a flexible waterproof material such as a plastic or synthetic rubber. Sidewalls 1611 must be strong enough to withstand the expected internal pressures of respective chambers 1601-n without rupturing or substantial ballooning. When chamber 1601-n is squeezed, ballooning is substantial if fluid goes into the balloon rather than being forced into a respective fluid release line 1605-n (described below). Internal pressure of bottom chamber 1601-N may be more than the internal pressure of top chamber 1601-1 due to the greater weight on bottom chamber 1601-N, consequently lower chambers as illustrated in FIG. 16 (such as chamber 1601-N) may have stronger sidewalls than upper chambers such as chamber 1601-1. Chambers 1601 are separated from one another by an interior divider 1615. Interior divider 1615 is generally planar in the XY plane, and may be constructed from a stiffer waterproof material than sidewalls 1611. Each of chambers 1601 is sealed with respect to another of chambers 1601.

Each of chambers 1601-n is coupled to a respective fluid fill line 1603-n and respective fluid release line 1605-n. For sake of clarity in FIG. 16, not all of fluid fill lines 1603-n and fluid release lines 1605-n are marked with a reference designator. Fluid fill lines 1603 are used to fill a respective chamber 1601 with fluid, e.g., by injection or by gravity. Each of fluid fill line 1603-n may include a respective input control valve 1607-n, which controls or permits flow of fluid into a respective chamber 1601-n. For example, when input control valve 1607-n is in an open position, fluid may flow into chamber 1601-n, and when input control valve 1607-n is in a closed position, no fluid is allowed to pass through input control valve 1607-n in either direction.

Fluid release lines 1605 are used to empty fluid from a respective chamber 1601, e.g., when chamber 1601-n is squeezed with sufficient pressure. Each of fluid fill line 1605-n may include a respective output control valve 1609-n, which controls or permits flow of fluid out of a respective chamber 1601-n. For example, when output control valve 1609-n is in an open position, fluid may flow out of chamber 1601-n, and when output control valve 1609-n is in a closed position, no fluid is allowed to pass through output control valve 1609-n.

Input control valve 1607-n and output control valve 1609-n may be a controllable valve such as a ball valve or butterfly valve coupled to a valve controller (not illustrated in FIG. 16). Valve controller may be powered by an external power source (e.g., a battery or wired AC power), which is unconnected to the energy stored in the energy storage apparatus. In other embodiments, at least input control valve 1607-n may be an automatic valve such as a check valve. A check valve when properly oriented would allow pressurized fill fluid to enter a respective chamber, but prevent pressurized contents of the respective chamber from back-flowing through the check valve. Output control valves 1609 should be controllable valves, since output control valve 1609-n should be closed during at least a portion of the time that pressure inside chamber 1601-n is expected to be high.

In operation of multi-tier bladder 1600, chambers 1601-n may be filled in a predetermined sequential order. For example, chamber 1601-N may be filled first and chamber 1601-1 to be filled last, so that a bladder being filled is not squeezed by the weight of a full bladder above it. The fill sequence may be controlled by controlling the open/closed states of input control valves 1607-n. In the case of automatic input control valves 1607, filling of a chamber 1601-n may be controlled by a sufficiently high fluid pressure applied to fluid entering the respective fluid fill line 1603-n.

Emptying of multi-tier bladder 1600 begins when downward external pressure is applied to the top of upper surface 1613 of multi-tier bladder 1600. Upper surface 1613 may be substantially rigid and be configured to cover substantially the entire cross-sectional area of chamber 1601-1. Application of this pressure is previously described in the context of FIG. 1, in which bladders 110, 112 are squeezed by weights in order to empty them. Multi-tier bladder 1600 also may be emptied in a predetermined sequential order. For example, chamber 1601-N may be emptied first and chamber 1601-1 may be emptied last, so that a bladder being emptied is also squeezed by the weight of a full bladder above it. After each chamber 1601-n of multi-tier bladder 1600 has been substantially emptied, multi-tier bladder 1600 is available to be filled again when the overall apparatus of FIG. 1 is in the appropriate position.

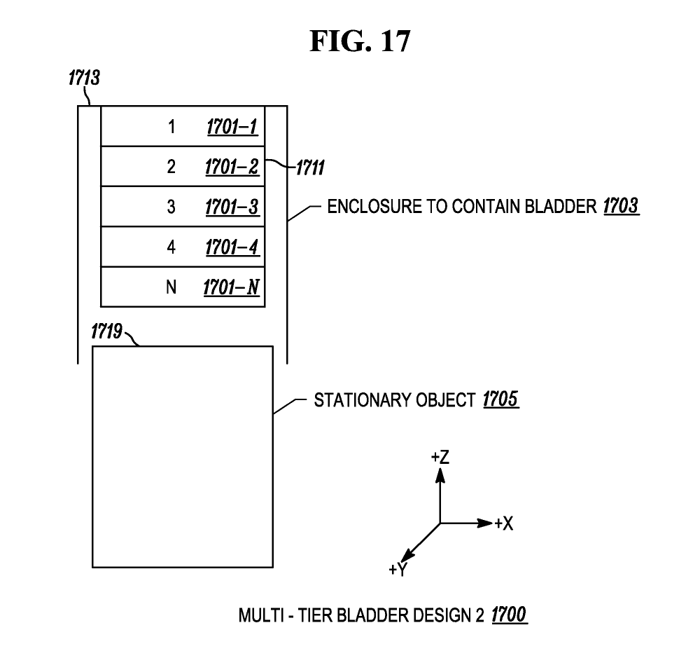

FIG. 17 illustrates a cross-sectional view in an XZ plane of multi-tier bladder 1700 in accordance with an embodiment of the present disclosure. Multi-tier bladder 1700 may be used for bladders 110, 112 depicted in FIG. 1. Multi-tier bladder 1700 includes a plurality of chambers 1701-1, 1701-2, 1701-3, 1701-4 . . . 1701-N, in which “N” is an integer greater than or equal to two. A single but unspecified chamber may be referred to herein as chamber 1701 or chamber 1701-n. The plurality of chambers may be referred to herein as chambers 1701. Chambers 1701 may be arranged in a generally vertical stack, with chamber 1701-n directly on top of chamber 1701-(n+1). Chambers 1701 may have a cross-sectional shape in the XY plane of substantially any shape, e.g., circular, oval, rectangular, square, or an arbitrary shape. Cross-sectional shapes of all chambers 1701 may be substantially the same.

Other components of multi-tier bladder 1700 such as fluid fill lines, fluid release lines, input control valves and output control valves are substantially the same as depicted in embodiment 1600, and so are not depicted in FIG. 17 so as not to obscure the salient elements of multi-tier bladder 1700.

As compared to multi-tier bladder 1600 of FIG. 16, multi-tier bladder 1700 of FIG. 17 includes an enclosure 1703. Enclosure 1703 may be open at the bottom, but may include a top surface 1713. Top surface 1713 extends across substantially all of the cross-sectional area in the XY plane of chamber 1701-1, without any openings of sufficient size to allow ballooning. Enclosure 1703 may be useful to help prevent ballooning of a chamber 1701-n as it is being squeezed when being emptied. Reliance upon enclosure 1703 to prevent ballooning, rather than the strength of the sidewalls themselves, means that sidewalls 1711 of chambers 1701-n do not need to be as strong as sidewalls 1611. Consequently, sidewalls 1711 may be thinner, lighter, and more flexible than sidewalls 1611.

Embodiment may further include a stationary object 1705 that includes a top surface 1719 upon which the multi-tier bladder 1700 may be pressed when multi-tier bladder 1700 is squeezed to force out fluid. The cross-sectional sizes of enclosure 1703 and stationary object 1705 may be matched in order to provide a tight coupling, similar to the lubricated coupling between a piston and a cylinder.

In operation as multi-tier bladder 1700 is being emptied, a downward force may be applied to the top side of top surface 1713. Enclosure 1703 may move downward relative to stationary object 1705 as multi-tier bladder 1700 is emptied. Openings (e.g., slots or the like) may be provided in the sidewall of enclosure 1703 in order to permit fluid fill lines 1603 and fluid release lines 1605 to maintain coupling with multi-tier bladder 1700 as enclosure 1703 moves relative to multi-tier bladder 1700 and relative to stationary object 1705.

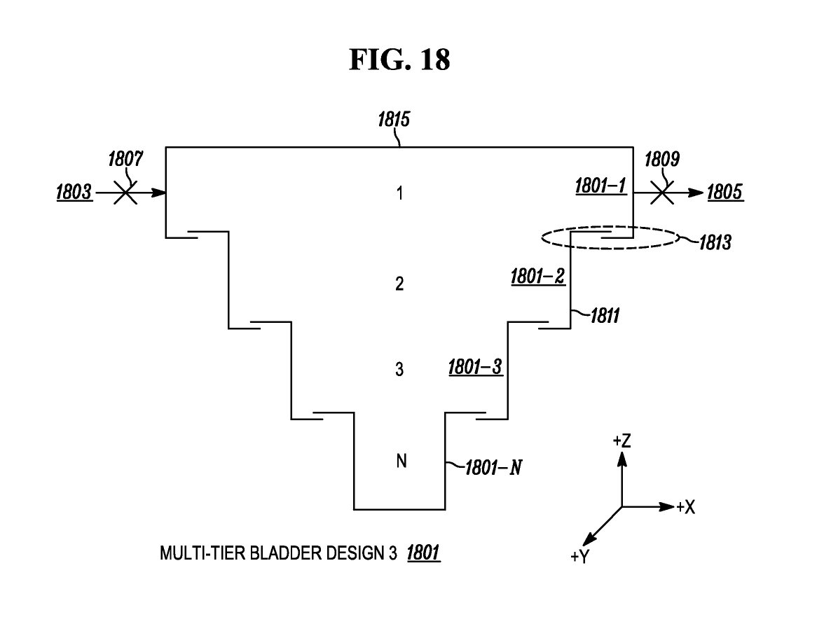

FIG. 18 illustrates a cross-sectional view in an XZ plane of multi-sectional bladder 1800 in accordance with an embodiment of the present disclosure. Multi-sectional bladder 1800 may be used for bladders 110, 112 depicted in FIG. 1. Multi-sectional bladder 1800 includes a plurality of sections 1801-1, 1801-2, 1801-3 . . . 1801-N, in which “N” is an integer greater than or equal to two. A single but unspecified section may be referred to herein as section 1801 or section 1801-n. The plurality of sections may be referred to herein as sections 1801. Sections 1801 may be arranged in a generally vertical stack, with section 1801-n directly on top of section 1801-(n+1). Sections 1801 may have a cross-sectional shape in the XY plane of substantially any shape, e.g., circular, oval, rectangular, square, or an arbitrary shape.

Multi-sectional bladder 1800 is telescoping, such that as one section is emptied, it may be collapsed so that its volume is incorporated into the volume of another section. Sidewalls 1811 of sections 1801 must be strong enough to withstand the internal pressure of sections 1801 without substantial ballooning or deformation. In some embodiments, sidewalls 1811 may be rigid. A sufficiently tight coupling region 1813 may be provided between adjacent sections 1801 in order for the adjacent sections to telescope relative to each other, without rupture or leakage of fluid from multi-sectional bladder 1800. The separation between sections 1801 within coupling region 1813 is exaggerated in FIG. 6 in order to better show the functional relationship.

Multi-sectional bladder 1800 includes a single fluid fill line 1803 and a single fluid release line 1805. Fluid fill line 1803 may include an input control valve 1807, and fluid release line 1805 may include an output control valve 1809. An upper surface 1815 of multi-sectional bladder 1800 provides a surface upon which external pressure may be applied to multi-sectional bladder 1800 in order to force out fluid.

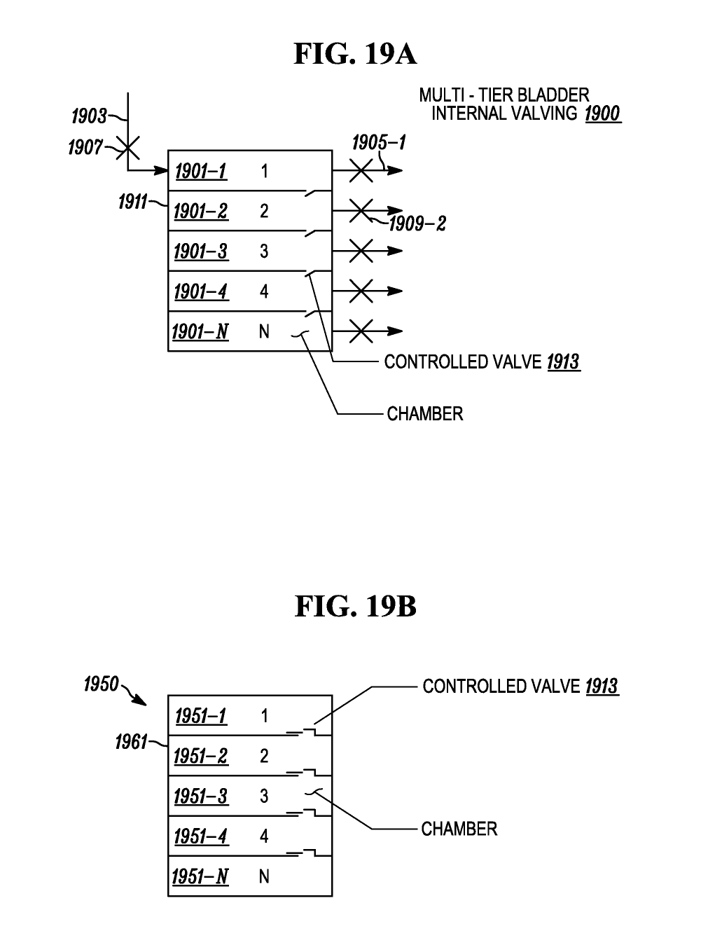

FIG. 19A illustrates a cross-sectional view in an XZ plane of multi-tier bladder 1900 in accordance with an embodiment of the present disclosure. Multi-tier bladder 1900 may be used for bladders 110, 112 depicted in FIG. 1. Multi-tier bladder 1900 includes a plurality of chambers 1901-1, 1901-2, 1901-3, 1901-4 . . . 1901-N, in which “N” is an integer greater than or equal to two. A single but unspecified chamber may be referred to herein as chamber 1901 or chamber 1901-n. The plurality of chambers may be referred to herein as chambers 1901. Chambers 1901 may be arranged in a generally vertical stack, with chamber 1901-n directly on top of chamber 1901-(n+1). Chambers 1901 may have a cross-sectional shape in the XY plane of substantially any shape, e.g., circular, oval, rectangular, square, or an arbitrary shape. Cross-sectional shapes of all chambers 1901 may be substantially the same. Chambers 1901 include sidewalls 1911.

Each of chambers 1901 (except for bottom chamber 1901-N) also includes a respective controlled valve 1913-n. Controlled valve 1913-n may be implemented as a butterfly valve or the like. Controlled valve 1913-n is controlled by a valve controller (not illustrated in FIG. 19A). Valve controller may be powered by an external power source (e.g., a battery or wired AC power), which is independent of (i.e., unconnected to) the energy stored in the energy storage apparatus.

A single fluid fill line 1903 and fill valve 1907 may be used to fill multi-tier bladder 1900. As each chamber 1901 of multi-tier bladder 1900 is to be filled or about to be filled, a respective valve 1913-n may be controlled to let fluid flow between chambers 1901. Each chamber 1901-n may be coupled to a respective fluid release line 1905-n and output control valve 1909-n.

FIG. 19B illustrates a cross-sectional view in an XZ plane of multi-tier bladder 1950 in accordance with an embodiment of the present disclosure. Multi-tier bladder 1950 may be used for bladders 110, 112 depicted in FIG. 1. Multi-tier bladder 1950 includes a plurality of chambers 1951-1, 1951-2, 1951-3, 1951-4 . . . 1951-N, in which “N” is an integer greater than or equal to two. A single but unspecified chamber may be referred to herein as chamber 1951 or chamber 1951-n. The plurality of chambers may be referred to herein as chambers 1951. Chambers 1951 may be arranged in a generally vertical stack, with chamber 1951-n directly on top of chamber 1951-(n+1). Chambers 1951 may have a cross-sectional shape in the XY plane of substantially any shape, e.g., circular, oval, rectangular, square, or an arbitrary shape. Cross-sectional shapes of all chambers 1951 may be substantially the same. Chambers 1951 include sidewalls 1951.

Similar to embodiment 1900, each of chambers 1951 (except for bottom chamber 1951-N) in embodiment 1950 also includes a respective controlled valve 1953-n. Controlled valve 1953-n may be implemented as a sliding valve, sliding door, or the like. Controlled valve 1953-n is controlled by a valve controller (not illustrated in FIG. 19A). Valve controller may be powered by an external power source (e.g., a battery or wired AC power), which is unconnected to the energy stored in the energy storage apparatus. As each chamber 1951-n of multi-tier bladder 1950 is filled or about to be filled, a respective valve 1953-n may be controlled to let fluid flow between chambers 1951.

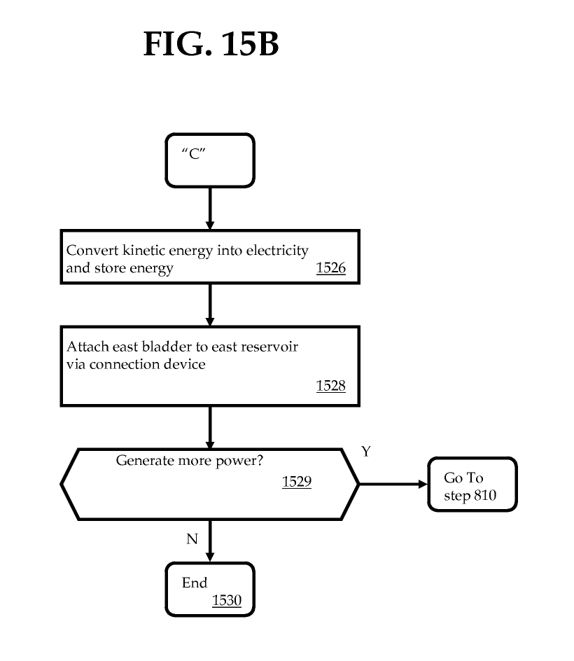

FIGS. 15A-15B are a flowchart illustrating an exemplary method 1500 of using a power generation system. While any embodiment of a power generation system described above may be utilized in the method, power generation system 100 is referenced as an example. The method 1500 begins at step 1502. At step 1504, the power generation system 100 is provided. At step 1506, the user positions the power generation system 100 in its startup position by attaching the east bladder 112 to the east reservoir 116 via the discharge pipe 128 and connection device 136. Alternatively, the startup position may be with the west bladder 110 attached to the west reservoir 114 via the discharge pipe 126 and connection device 134.

As step 1508, the user fills one of reservoirs 114, 116 with fluid. In addition, transfer pipes 120,118 are filled with fluid, for example water. The opposing reservoir that was filled to full will need to be filled with fluid to a level above the discharge pipe, 126, 128. This additional volume of fluid may be helpful to prevent air from entering discharge pipes 126,128.

At step 1510, the user initiates the power generation system 100 by opening valve 132, thereby allowing the fluid to flow from the reservoir 116 to the bladder 112 through the discharge pipe 128. The valve 132 may be opened manually. Alternatively, the valve may be controlled by an actuator, whereby the user opens the valve 132 by sending a signal from a controller. At step 1512, the valve 132 is closed when bladder 112 is filled. Again, this may be done manually or automatically. The bladder 112 may comprise a level sensor that when the fluid level reaches the sensor, a signal is sent to the actuator of valve 132, commanding it to close. Alternatively, the power generation system 100 may comprise a timer that controls the duration of time valve 132 is open.

At step 1514, the connection device 136 is released such that bladder 112 is no longer connected to the reservoir 116. This may be done manually or automatically. The signal sent to close valve 132 may simultaneously be sent to the connection device 136 commanding it to release.

As the power generation system is in motion due to the descent of the filled bladder 112, the drive gears 142 and 144 and transfer gears 146 and 148 will be rotating. At step 1516, the rotational energy generated from the rotation of transfer gear 146 will be converted into electricity by the energy converter 154, and either sent to a user directly or stored, for example by batteries.

At step 1518, the west bladder 110 is attached to the west reservoir 114 via the discharge pipe 126 and connection device 134. At step 1520, the valve 130 is opened to allow the fluid to flow from reservoir 114 to bladder 110 through the discharge pipe 126. As with step 1510, this may be performed manually or automatically by the same means. At step 1522, the valve 130 is closed when bladder 110 is filled. Again, this may be done manually or automatically by the same means as in step 1512. At step 1524, the connection device 134 is released such that bladder 110 is no longer connected to the reservoir 114. This may be done manually or automatically by the same means as in step 1514. At step 1526, the rotational energy generated from the rotation of transfer gear 148 will be converted into electricity by the energy converter 154, and either sent to a user directly or stored, for example by batteries. At step 1528, the east bladder 112 is attached to the east reservoir 116 via the connection device 128, thereby completing one cycle of operation of the power generation system 100. The process may then repeat steps 1510 through 1528. The method ends at step 1530.

While the foregoing is directed to embodiments of the invention, other and further embodiments of the invention may be devised without departing from the basic scope thereof. In particular, it should be appreciated that any element of any embodiments disclosed herein may be combined with any other elements from any other embodiments disclosed herein, in accordance with yet further embodiments of the present invention.

We claim:

1. An energy storage system comprising:
a pivotable linkage comprising: a first end; a second end distal from the first end; and a pivot point midway between the first end and the second end;
a first collapsible fluid container coupled to the first end of the pivotable linkage;
a second collapsible fluid container coupled to the second end of the pivotable linkage;
a first fluid reservoir coupled to the second collapsible fluid container by a first transfer tube, the first transfer tube configured to allow transfer of fluid from the second collapsible fluid container to the first fluid reservoir;
a second fluid reservoir coupled to the first collapsible fluid container by a second transfer tube, the second transfer tube configured to allow transfer of fluid from the first collapsible fluid container to the second fluid reservoir;
a first reservoir transfer apparatus, configured to transfer fluid from the first reservoir to the first collapsible fluid container;
a second reservoir transfer apparatus, configured to transfer fluid from the second reservoir to the second collapsible fluid container;
a first weight detachably connectable to a first fluid bladder assembly, the first fluid bladder assembly comprising the first collapsible fluid container;
a second weight detachably connectable to a second fluid bladder assembly, the second fluid bladder assembly comprising the second collapsible fluid container; and
a hub coupled to the pivotable linkage at the pivot point, wherein the hub is configured to harvest energy stored as potential energy of the water and kinetic energy of the system, without an addition of external energy to the hub.

2. The energy storage system of claim 1, wherein the hub comprises:
an electrical generator;
a first drive mechanism coupling the electrical generator to the pivot point of the pivotable linkage, wherein the first drive mechanism is configured to drive the electrical generator by a clockwise motion of the pivotable linkage; and
a second drive mechanism coupling the electrical generator to the pivot point of the pivotable linkage, wherein the second drive mechanism is configured to drive the electrical generator by a counter-clockwise motion of the pivotable linkage.

3. The energy storage system of claim 1, wherein the hub comprises:
a first electrical generator;
a second electrical generator;
a first drive mechanism coupling the first electrical generator to the pivot point of the pivotable linkage, wherein the first drive mechanism is configured to drive the first electrical generator by a clockwise motion of the pivotable linkage; and
a second drive mechanism coupling the second electrical generator to the pivot point of the pivotable linkage, wherein the second drive mechanism is configured to drive the second electrical generator by a counter-clockwise motion of the pivotable linkage.

4. The energy storage system of claim 1, wherein:
the first weight comprises:
a first attachment mechanism configured to couple the first weight to a first fixed support; and
a second attachment mechanism configured to couple the first weight to the first collapsible fluid container; and
the second weight comprises:
a first attachment mechanism configured to couple the second weight to a second fixed support; and
a second attachment mechanism configured to couple the second weight to the second collapsible fluid container.

5. The energy storage system of claim 4, wherein the first attachment mechanism of the first weight is configured to couple the first weight to the first fixed support at substantially the same time as the second attachment mechanism of the second weight is configured to couple the second weight to the second collapsible fluid container.

6. The energy storage system of claim 4, wherein the first and second attachment mechanisms of the first and second weights further comprises an interface to an external power source, wherein the external power source is isolated from the hub, and wherein power from the external power source is used to activate the transfer mechanisms.

7. The energy storage system of claim 1, wherein the first weight is operable to compress the first collapsible fluid container in order to force fluid from the first collapsible fluid container through the second transfer tube to the second fluid reservoir.

8. The energy storage system of claim 1, wherein the first and second transfer tubes further comprise a respective backflow preventer.

9. The energy storage system of claim 1, further comprising a first and second contact component configured to provide a platform to squeeze the first and second collapsible fluid containers, respectively.

10. The energy storage system of claim 9, wherein the first and second contact component comprises a cavity configured to accept their respective collapsible fluid container.

11. The energy storage system of claim 1, wherein the first fluid reservoir comprises a collapsible fluid reservoir container.

12. The energy storage system of claim 1, wherein the first fluid reservoir, the second collapsible fluid container and the first transfer tube form a sealable assembly.

13. The energy storage system of claim 1, wherein the first reservoir transfer apparatus is separable from the first collapsible fluid container.

14. The energy storage system of claim 1, wherein the first reservoir transfer apparatus comprises a reservoir transfer tube.

15. The energy storage system of claim 14, wherein the first fluid reservoir, the second collapsible fluid container, the first transfer tube, a first reservoir transfer tube, the second fluid reservoir, the first collapsible fluid container, a second reservoir transfer tube and the second transfer tube form a sealed assembly.

16. The energy storage system of claim 1, wherein the first and second reservoir transfer apparatus further comprise a respective shutoff valve.

17. A method to operate an energy storage system, comprising the steps of:
providing a pivotable linkage comprising: a first end; a second end distal from the first end; and a pivot point midway between the first end and the second end;
allowing fluid to flow by gravity from a first fixed-place reservoir to a collapsible fluid container coupled to the second end of the pivotable linkage;
allowing the first end of the pivotable linkage to pivot downward by gravity, relative to the second end of the pivotable linkage;
detaching a second weight from the second end of the pivotable linkage;
attaching a first weight to the first end of the pivotable linkage, wherein the first weight is operable to squeeze fluid from the first collapsible container to a second fixed-place reservoir;
allowing fluid to flow by gravity from the second fixed-place reservoir to a collapsible fluid container coupled to the second end of the pivotable linkage;
allowing the second end of the pivotable linkage to pivot downward by gravity, relative to the first end of the pivotable linkage;
detaching the first weight from the first end of the pivotable linkage;
attaching the second weight to the second end of the pivotable linkage, wherein the second weight is operable to squeeze fluid from the second collapsible container to the first fixed-place reservoir; and
coupling a hub to the pivotable linkage at the pivot point, wherein the hub is configured to harvest energy stored as potential energy of the water and kinetic energy of the system, without adding external energy to the hub.

18. The energy storage system of claim 1, wherein at least one of the first collapsible fluid container and the second collapsible fluid container comprises a multi-chamber container.

19. The energy storage system of claim 18, further comprising a respective valve coupled to each chamber of the multi-chamber container, in order to control fluid flow into or out of said chamber.

20. The energy storage system of claim 18, wherein the respective valve is situated inside the multi-chamber container.
